(19) United States
(12) Patent Application Publication
(10) Pub. No.: US 2020/0131363 A1
(43) Pub. Date: Apr. 30, 2020

(54) POLYURETHANE PHASE-CHANGE COMPOSITIONS AND METHODS OF MANUFACTURE THEREOF

(71) Applicant: ROGERS CORPORATION, Chandler, AZ (US)

(72) Inventors: Ming Wei, Cranston, RI (US); Brian Litke, Brooklyn, CT (US)

(21) Appl. No.: 16/589,766

(22) Filed: Oct. 1, 2019

Related U.S. Application Data
(60) Provisional application No. 62/751,140, filed on Oct. 26, 2018.

(51) Int. Cl. C08L 75/04; C08G 18/36; C08G 18/62; B01J 23/14; B01J 23/16; B01J 23/06; B01J 23/745

(52) U.S. Cl. CPC C08L 75/04; C08G 18/36; C08G 18/627; C08K 5/0066; B01J 23/16; B01J 23/06; B01J 23/745; B01J 23/14

(57) ABSTRACT

A method of manufacturing a polyurethane phase-change composition comprises forming a curable composition comprising a homogeneous mixture of an organic isocyanate, a polyol having a hydroxyl functionality of 1.5 to 5, and a phase-change material; and curing the curable composition to obtain a polyurethane phase-change composition, wherein the polyurethane phase-change composition has a transition temperature, determined by differential scanning calorimetry according to ASTM D3418, of 5 to 70° C.

### CROSS-REFERENCE TO RELATED APPLICATIONS

This application claims the benefit of U.S. Provisional Application Ser. No. 62/751,140, filed Oct. 26, 2018, which is incorporated herein by reference in its entirety.

### BACKGROUND

This disclosure relates to phase-change materials (PCMs), methods of manufacture thereof, and articles containing the PCMs.

Thermal management is desirable in a wide range of devices, including batteries, devices containing light-emitting diodes (LEDs), and devices containing circuits. For example, circuit designs for electronic devices such as televisions, radios, computers, medical instruments, business machines, and communications equipment have become increasingly smaller and thinner. The increasing power of such electronic components has resulted in increasing heat generation. Moreover, smaller electronic components are being densely packed into ever smaller spaces, resulting in more intense heat generation. Additionally, fast charging has been a new trend for the portable electronic device industry. However, fast charging tends to introduce the problem of overheating in the device.

At the same time, electronic devices can be very sensitive to over-heating, negatively influencing both lifetime and reliability of the parts. Temperature-sensitive elements in electronic devices may need to be maintained within a prescribed operating temperature in order to avoid significant performance degradation or even system failure. Consequently, manufacturers are continuing to face the challenge of dissipating heat generated in electronic devices, i.e., thermal management. Moreover, the internal design of electronic devices may include irregularly shaped cavities that present a significant challenge for known thermal management approaches.

Accordingly, there remains a need for new approaches for thermal management in various devices, and particularly in electronic devices. It would be an additional advantage if the solutions were effective for small or thin devices or devices with irregularly-shaped cavities.

### BRIEF SUMMARY

A method of manufacturing a polyurethane phase-change composition comprises forming a curable composition comprising a homogeneous mixture of an organic isocyanate, a polyol having a hydroxyl functionality of 1.5 to 5, and a phase-change material; and curing the curable composition to obtain a polyurethane phase-change composition, wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

A polyurethane phase-change composition comprises the reaction product of a homogeneous mixture of an organic isocyanate, a polyol having a hydroxyl functionality of 1.5 to 5, and a phase-change material wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

Also disclosed are polyurethane phase-change compositions made by the method and articles comprising the polyurethane phase-change compositions.

The above described and other features are exemplified by the following figures and detailed description.

### BRIEF DESCRIPTION OF THE DRAWINGS

The following is a brief description of the drawings which are presented for the purposes of illustrating the exemplary embodiments disclosed herein and not for the purposes of limiting the same.

FIG. 1 is a graph showing heat flow (J/g) as a function of temperature (° C.) obtained by differential scanning calorimetry (DSC) on a sample of the gelled polyurethane phase-change composition of Example 1.

FIG. 2 is a graph showing heat flow (J/g) as a function of temperature (° C.) obtained by differential scanning calorimetry (DSC) on the polyurethane phase-change film of Example 2.

### DETAILED DESCRIPTION

Disclosed herein are novel polyurethane phase-change compositions having a high heat of fusion at the phase transition temperature and methods of manufacturing the polyurethane phase-change compositions. Polyurethanes are generally formed from reactive mixtures that include polyurethane-forming components, in particular organic isocyanate components and polyol-containing components that are substantially reactive with each other. The polyurethane phase-change compositions disclosed herein are formed from reactive mixtures that further include phase-change materials compatible with the reactive organic isocyanate components and polyol components. Prior to curing, the curable composition comprising the reactive organic isocyanate, polyol, and phase-change material can be easily introduced into a desired location of any shape by simple injection or can be cast solvent-free as a film.

These polyurethane phase-change compositions are especially suitable for providing excellent thermal protection to a wide variety of devices, and in particular electronic devices. The internal design of electronic devices can include irregularly shaped cavities that can be difficult to fill completely with solid phase-change materials to maximize heat absorption capacity. The polyurethane phase-change compositions disclosed herein have the benefit that the curable compositions, prior to gelling, can be readily injected into irregularly shaped cavities in such devices in order to maximize heat absorption capacity. After gelling, the polyurethane phase-change compositions are in gel form and therefore do not leak out of the device at the operating temperature of the device (e.g., less than 100° C. or less than 50° C.).

The polyurethane phase-change composition is manufactured by a method comprising forming a curable composition comprising a homogeneous mixture of an organic isocyanate, a polyol having a hydroxyl functionality of 1.5 to 5, preferably 1.5 to 2.9, and a phase-change material; and curing the curable composition to obtain a polyurethane phase-change composition. The polyurethane phase-change composition has a transition temperature, determined by differential scanning calorimetry according to ASTM D3418, of 5 to 70° C., 20 to 65° C., 25 to 60° C., 30 to 50° C., or 35 to 45° C. In some embodiments, the polyurethane phase-change composition has a heat of fusion of at least 140 J/g, preferably at least 170 J/g, more preferably at least 190 J/g, determined by differential scanning calorimetry according to ASTM D3418.

Careful selection of the organic isocyanate, the polyol, and the phase-change material permits tuning of the properties of the polyurethane phase-change compositions.

In some embodiments, forming a curable composition can comprise combining a first component comprising a homogeneous mixture of the organic isocyanate and the phase-change material and a second component comprising a homogeneous mixture of the polyol and the phase-change material to form the curable composition. The phase-change material in the first component and the second component can be the same or different. The phase-change material in the first component or the second component can be a melted phase-change material. In preferred embodiments, the phase-change material undergoes a solid to liquid transition at a temperature of 5 to 70° C., 20 to 65° C., 25 to 60° C., 30 to 50° C., or 35 to 45° C.

The organic isocyanate is selected to have compatibility with the phase-change material and to provide the final polyurethane composition with desired properties, such as gel time or compatibility with the phase-change material. The type and amount of organic isocyanate in the first component is selected to have good compatibility with the phase-change material, in order to form a homogeneous mixture of the organic isocyanate and a large quantity of the phase-change material. The phase-change material mixed with the organic isocyanate can be melted. The quantity of phase-change material in the first component can be, for example, at least 50% by weight, or at least 70% by weight, or at least 80% by weight, or at least 90% by weight of the first component, such as 50 to 95% by weight, or 70 to 95% by weight, or 80 to 95% by weight, or 90 to 95% by weight of the first component. Exemplary organic isocyanates include hexamethylene diisocyanate, 1,8-diisocyanato-p-methane, xylyl diisocyanate, diisocyanatocyclohexane, phenylene diisocyanates, toluene diisocyanates (including 2,4-toluene diisocyanate, 2,6-toluene diisocyanate, and crude toluene diisocyanate), bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, polymeric isocyanates such as an isocyanate-terminated polybutadiene, an isocyanate-terminated polyolefin, an isocyanate-derivatized vegetable oil, a prepolymer comprising at least one of the foregoing, a quasi-prepolymer comprising at least one of the foregoing, or a combination thereof. In certain embodiments, the organic isocyanate is a liquid at temperatures of 20 to 120° C. Preferably the organic isocyanate is an isocyanate-derivatized vegetable oil; more preferably the organic isocyanate is an isocyanate-derivatized castor oil.

The polyol having a hydroxyl functionality of 1.5 to 5, preferably 1.5 to 2.9, is selected with care to have compatibility with the phase-change material and to provide the final polyurethane composition with desired properties, such as gel time or compatibility with the phase-change material. The type and amount of polyol in the second component is selected to have good compatibility with the phase-change material in order to form a homogeneous mixture of the polyol and a large quantity of the phase-change material. The phase-change material mixed with the polyol can be melted. The quantity of phase-change material in the second component can be, for example, at least 50% by weight, or at least 70% by weight, or at least 80% by weight, or even at least 90% by weight of the second component, such as 50 to 95% by weight, or 70 to 95% by weight, or 80 to 95% by weight, or 90 to 95% by weight of the second component. Examples of a suitable polyol include a polyester polyol, a polyether polyol, a polycaprolactone, a hydrogenated hydroxyl-terminated polyolefin, a hydroxyl-terminated polybutadiene, and a combination thereof. In certain embodiments, the polyol is a liquid at temperatures of 20 to 120° C. Preferably, the polyol comprises a hydrogenated hydroxyl-terminated polyolefin, a hydroxyl-terminated polybutadiene, or a combination thereof. The number average molecular weight of the polyol can be 500 to 10,000 Daltons (Da), or 600 to 8000 Da, or 700 to 6000 Da, or preferably 800 to 4000 Da.

The polyols can have hydroxyl numbers that vary over a wide range. In general, the hydroxyl numbers of the polyols, including other cross-linking additives, if used, can be 11 to 1250, or 27 to 200. The hydroxyl number is defined as the number of milligrams of potassium hydroxide required for the complete neutralization of the hydrolysis product of the fully acetylated derivative prepared from 1 gram of polyol or mixtures of polyols with or without other cross-linking additives. The hydroxyl number can also be defined by the equation:

$$OH = \frac{56.1 \times 1000 \times f}{{M}_{W}}$$

wherein: OH is the hydroxyl number of the polyol,
f is the average functionality, that is the average number of hydroxyl groups per molecule of polyol, and
Mw is the average molecular weight of the polyol.

Chain extenders (f=2) or crosslinking agents (f>3) can be included in the second, polyol-containing component. Exemplary chain extenders and crosslinking agents have a molecular weight from 60 to 450. Exemplary chain extenders are diols, such as alkane diols and dialkylene glycols. Examples of chain extenders include ethylene glycol, diethylene glycol, dipropylene glycol, 1,4-butanediol, 1, 5-pentanediol, 1,6-hexanediol, cyclohexane dimethanol, hydroquinone bis(2-hydroxyethyl) ether, and the like. A combination thereof chain extenders can be used. Exemplary crosslinking agents are polyhydric alcohols, preferably triols and tetrols. The chain extenders and cross-linking agents can be used in amounts from 0.1 to 20 weight percent (wt. %), preferably from 0.5 to 10 wt. %, based on the total weight of the curable composition.

The organic isocyanate is used, for example, in proportions of 70 percent to 130 percent stoichiometric excess, or 80 percent to 120 percent stoichiometric excess, preferably 90 percent to 110 percent stoichiometric excess, the stoichiometry being based upon equivalents of isocyanate group per equivalent of hydroxyl in the polyol. The amount of organic isocyanate used will vary slightly depending upon the nature of the polyurethane being prepared.

It has been unexpectedly found that careful selection of the organic isocyanate and polyol results in a polyurethane compatible with large quantities of the phase-change material, providing an elastomer that can efficiently retain the phase-change material within its own matrix and can confer to the polyurethane phase-change composition an excellent heat management performance over long periods of time.

In a preferred embodiment a large amount of phase-change material is present in the polyurethane phase-change composition, in particular 40 to 95 weight percent, or 50 to 95 weight percent, or 60 to 95 weight percent, or 70 to 95 weight percent, or 80 to 95 weight percent, or 90 to 95 weight percent, or 50 to 90 weight percent, or 60 to 90 weight percent, or 70 to 85 weight percent, or 80 to 90 weight percent, based on the total weight of the polyurethane phase-change composition.

Compatibility of two materials, for example an organic isocyanate, a polyol, or a resultant polyurethane with a given phase-change material, can be assessed by comparing the “solubility parameter” (δ) of each material. Solubility parameters can be determined by any suitable method in the art or obtained for many compounds from published tables. The organic isocyanate, polyol, or resultant polyurethane should have a solubility parameter similar to the solubility parameter of the phase-change material to form a compatible blend. Two solubility parameters can be considered similar when they differ by no more than ±1, or ±0.9, or ±0.8, or ±0.7, or ±0.6, or ±0.5, or ±0.4, or ±0.3.

A phase-change material (PCM) is a substance with a high heat of fusion that can absorb and release high amounts of latent heat during a phase transition, such as melting and solidification, respectively. During the phase change, the temperature of the phase-change material remains nearly constant. The phase-change material inhibits or stops the flow of thermal energy through the material during the time the phase-change material is absorbing or releasing heat, typically during the material's change of phase. In some instances, a phase-change material can inhibit heat transfer during a period of time when the phase-change material is absorbing or releasing heat, typically as the phase-change material undergoes a transition between two states. This action is typically transient and will occur until a latent heat of the phase-change material is absorbed or released during a heating or cooling process. Heat can be stored or removed from a phase-change material, and the phase-change material typically can be effectively recharged by a source of heat or cold.

Phase-change materials thus have a characteristic transition temperature. The term “transition temperature,” or “phase-change temperature” refers to an approximate temperature at which a material undergoes a transition between two states. In some embodiments, e.g. for a commercial paraffin wax of mixed composition, the transition “temperature” can be a temperature range over which the phase transition occurs.

In principle, it is possible to use phase-change materials having a phase-change temperature of −100 to 150° C. in the phase-change compositions. For use in LED and electronic components, in particular, the phase-change material incorporated into the phase-change compositions can have a phase-change temperature of 0 to 115° C., 10 to 105° C., 20 to 100° C., or 30 to 95° C. In an embodiment, the phase-change material has a melting temperature of 25 to 105° C., or 28 to 60° C., or 45 to 85° C., or 60 to 80° C., or 80 to 100° C.

The selection of a phase-change material typically depends upon the transition temperature that is desired for a particular application that is going to include the phase-change material. For example, a phase-change material having a transition temperature near normal body temperature or around 37° C. can be desirable for electronics applications to prevent user injury and protect overheating components. The phase-change material can have a transition temperature in the range of −5 to 150° C., or 0 to 90° C., or 30 to 70° C., or 35 to 50° C.

The transition temperature can be expanded or narrowed by modifying the purity of the phase-change material, molecular structure, blending of phase-change materials, or any combination thereof.

The phase-change material in the first, isocyanate component and the phase-change material in the second, polyol component can be identical or different. For certain embodiments, the phase-change material in the first, isocyanate component and the phase-change material in the second, polyol component are different materials.

Further, the phase-change material can be selected to be a single material or a mixture of materials. By selecting two or more different phase-change materials and forming a mixture, the temperature stabilizing range of the phase-change material can be adjusted for any desired application. A temperature stabilizing range can include a specific transition temperature or a range of transition temperatures. The resulting mixture can exhibit two or more different transition temperatures or a single modified transition temperature when incorporated in the phase-change compositions described herein.

In some embodiments, it can be advantageous to have multiple or broad transition temperatures. If a single narrow transition temperature is used, this can cause thermal/energy buildup before the transition temperature is reached. Once the transition temperature is reached, then energy will be absorbed until the latent energy is consumed and the temperature will then continue to increase. Broad or multiple transition temperatures allow for temperature regulation and thermal absorption as soon the temperature starts to increase, thereby alleviating any thermal/energy buildup. Multiple or broad transition temperatures can also more efficiently help conduct heat away from a component by overlapping or staggering thermal absorptions. For instance, for a composition containing a first phase-change material (PCM1) which absorbs at 35 to 40° C. and a second phase-change material (PCM2) which absorbs at 38 to 45° C., PCM1 will start absorbing and controlling temperature until a majority of the latent heat is used, at which time PCM2 will start to absorb and conduct energy from PCM1 thereby rejuvenating PCM1 and allowing it to keep functioning.

The selection of the phase-change material can depend on the latent heat of the phase-change material. A latent heat of the phase-change material typically correlates with its ability to absorb and release energy/heat or modify the heat transfer properties of the article. In some instances, the phase-change material can have a latent heat of fusion that is at least 20 J/g, such as at least 40 J/g, at least 50 J/g, at least 70 J/g, at least 80 J/g, at least 90 J/g, or at least 100 J/g. Thus, for example, the phase-change material can have a latent heat of fusion of 20 J/g to 400 J/g, such as 60 J/g to 400 J/g, 80 J/g to 400 J/g, or 100 J/g to 400 J/g.

Phase-change materials that can be used include various organic and inorganic substances. Examples of phase-change materials include hydrocarbons (e.g., straight-chain alkanes or paraffinic hydrocarbons, branched-chain alkanes, unsaturated hydrocarbons, halogenated hydrocarbons, and alicyclic hydrocarbons), silicone wax, alkanes, alkenes, alkynes, arenes, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, fatty acids (caproic acid, caprylic acid, lauric acid, myristic acid, palmitic acid, stearic acid, arachidic acid, behenic acid, lignoceric acid and cerotic acid, etc.), fatty acid esters (methyl caprylate, methyl caprate, methyl laurate, methyl myristate, methyl palmitate, methyl stearate, methyl arachidate, methyl behenate, methyl lignocerate, and the like), fatty alcohols (capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol, and the like), dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and mixtures thereof. Various vegetable oils can be used, for example soybean oil, palm oil, castor oil or the like. Such oils can be purified or otherwise treated to render them suitable for use as phase-change materials. In an embodiment a phase-change material used in the phase-change composition is an organic substance.

Paraffinic phase-change materials can be a paraffinic hydrocarbon, that is, a hydrocarbon represented by the formula CₙHₙ₊₂, where n can range from 10 to 44 carbon atoms. The melting point and heat of fusion of a homologous series of paraffin hydrocarbons is directly related to the number of carbon atoms.

Similarly, the melting point of a fatty acid depends on the chain length.

In an embodiment, the phase-change material comprises a paraffinic hydrocarbon, a fatty acid, or a fatty acid ester having 15 to 40 carbon atoms, 18 to 35 carbon atoms, or 18 to 28 carbon atoms. The phase-change material can be a single paraffinic hydrocarbon, fatty acid, or fatty acid ester, or a mixture of hydrocarbons, fatty acids, or fatty acid esters. The phase-change material can be a vegetable oil. In a preferred embodiment the phase-change material has a melting temperature of 5 to 70° C., 20 to 65° C., 25 to 60° C., or 30 to 50° C., or 35 to 45° C.

The heat of fusion of the phase-change material, determined by differential scanning calorimetry according to ASTM D3418, can be greater than 150 Joules/gram, preferably greater than 180 Joules per gram, more preferably greater than 200 Joules/gram.

The amount of the phase-change material in the first, isocyanate-containing, component depends on the type of phase-change material used, the desired phase-change temperature, the type of organic isocyanate used, and like considerations, but is selected to provide a compatible blend of the phase-change material and the organic isocyanate after mixing. The amount of the phase-change material in the first component can be at least 50 weight percent, at least 55 weight percent, at least 60 weight percent, at least 65 weight percent, at least 70 weight percent, at least 75 weight percent, at least 80 weight percent, at least 85 weight percent, or at least 90 weight percent, and no more than 97 weight percent, or no more than 95 weight percent of the total weight of the first component, provided that a compatible blend of the phase-change material and the organic isocyanate is obtained after mixing. The phase-change material mixed with the organic isocyanate can be melted.

The amount of the phase-change material in the second, polyol-containing, component depends on the type of phase-change material used, the desired phase-change temperature, the type of polyol used, and like considerations, but is selected to provide a compatible blend of the phase-change material and the polyol after mixing. The amount of the phase-change material in the second component can be at least 45 weight percent, at least 50 weight percent, at least 55 weight percent, at least 60 weight percent, at least 65 weight percent, at least 70 weight percent, at least 75 weight percent, at least 80 weight percent, at least 85 weight percent, or at least 90 weight percent, and no more than 97 weight percent, or no more than 95 weight percent, wherein weight percent is based on the total weight of the second component, provided that a compatible blend of the phase-change material and the polyol is obtained after mixing. The phase-change material mixed with the polyol can be melted.

The phase-change material includes an unencapsulated (“raw”) phase-change material and can optionally include an encapsulated phase-change material. The amount of encapsulated phase-change material when present in the phase-change material can be 10 to 95 weight percent, 30 to 90 weight percent, 40 to 75 weight percent, or 50 to 70 weight percent of the total weight of the phase-change material.

A catalyst can be included in the curable composition to accelerate the gel time for elastomer formation. The catalyst, if present, can be included in the second, polyol-containing, component or can be added to the curable composition in a third component. Curing the curable composition, in the presence of a catalyst, preferably takes place at a temperature of 20° C. to 120° C., and takes 1 minute to 6 hours, or 5 minutes to 4 hours.

Examples of catalysts include tertiary amines and organometal catalysts. The metal can be tin, bismuth, iron, zinc, or a combination thereof. Examples of tin catalysts include tin(II)acetate, tin(II)octanoate, tin(II)laurate, dibutyltin dilaurate, dibutyltin dimaleate, dioctyltin diacetate and dibutyltin dichloride. Examples of tertiary amines include triethylamine, 1,4-diazabicyclo[2.2.2.]octane (DABCO), N-methylmorpholine, N-ethylmorpholine, N,N,N′,N′-tetramethylhexamethylenediamine, and 1,2-dimethylimidazol. A single catalyst or a combination thereof catalysts can be included in the reaction, as appropriate. The type and quantity of catalyst are selected to obtain a desired gel time after mixing the first and second components. The amount of catalyst, when present, can be 0.1 to 10 weight percent (wt. %), preferably 1 to 8 wt. %, more preferably 2 to 6 wt. %, based on total weight of the polyol and the isocyanate. Alternatively, the amount of catalyst, when present, can be 0.1 to 2.5 weight percent (wt. %), preferably 0.5 to 2 wt. %, more preferably 0.5 to 1.5 wt. %, based on total weight of the polyurethane phase-change composition.

The polyurethane phase-change compositions can further comprise other components as additives, such as a flame retardant, a filler such as a thermoconductive filler, a thermally insulating filler, or a magnetic filler; a dispersing aid, an adhesion promotor, a colorant, a plasticizer, a thermal stabilizer, an antioxidant, epoxy compounds, or a combination thereof. Such additional components are selected so as to not significantly adversely affect the desired properties of the polyurethane phase-change compositions, such as the gelling time of the curable composition and heat of fusion of the polyurethane phase-change compositions. Usually, the amount of the additive used is, based on total weight of polyurethane phase-change composition, up to 50 weight percent, or 0.01 to 30 weight percent, or 0.01 to 15 weight percent, or 0.01 to 10 weight percent or 0.01 to 5 weight percent, wherein weight percent is based on the total weight of the polyurethane phase-change composition, and weight percents total to 100 weight percent. In the method of manufacture, the additive can be included in the polyol component or can be a separate component.

A filler can optionally be present to adjust the dielectric, thermally conductive, or magnetic properties of the phase-change composition. A low coefficient of expansion filler, such as glass beads, silica or ground micro-glass fibers, can be used. A thermally stable fiber, such as an aromatic polyamide, or a polyacrylonitrile can be used. Representative dielectric fillers include titanium dioxide (rutile and anatase), barium titanate, strontium titanate, fused amorphous silica, corundum, wollastonite, aramide fibers (e.g., KEVLAR™ from DuPont), fiberglass, Ba₂Ti₉O₂₀, quartz, aluminum nitride, silicon carbide, beryllia, alumina, magnesia, mica, talcs, nanoclays, aluminosilicates (natural and synthetic), iron oxide, CoFe₂O₄ (nanostructured powder available from Nanostructured & Amorphous Materials, Inc.), single wall or multiwall carbon nanotubes, and fumed silicon dioxide (e.g., Cab-O-Sil, available from Cabot Corporation), each of which can be used alone or in combination.

Other types of fillers that can be used include a thermoconductive filler, a thermally insulating filler, a magnetic filler, or a combination thereof. Thermoconductive fillers include, for example, boron nitride, silica, alumina, zinc oxide, magnesium oxide, and aluminum nitride. Examples of thermally insulating fillers include, for example, organic polymers in particulate form. The magnetic fillers can be nanosized.

The fillers can be in the form of solid, porous, or hollow particles. The particle size of the filler affects a number of important properties including coefficient of thermal expansion, modulus, elongation, and flame resistance. In an embodiment, the filler has an average particle size of 0.1 to 15 micrometers, specifically 0.2 to 10 micrometers. The filler can be a nanoparticle, i.e., a nanofiller, having an average particle size of 1 to 100 nanometers (nm), or 5 to 90 nm, or 10 to 80 nm, or 20 to 60 nm. A combination of fillers having a bimodal, trimodal, or higher average particle size distribution can be used. The filler can be included in an amount of 0.5 to 60 weight percent, or 1 to 50 weight percent, or 5 to 40 weight percent, based on a total weight of the phase-change composition.

Representative flame retardant additives include bromine-, phosphorus-, and metal oxide-containing flame retardants. Suitable bromine-containing flame retardants are generally aromatic and contain at least two bromines per compound. Some that are commercially available are from, for example, Albemarle Corporation under trade names Saytex BT-93W (ethylenebistetrabromonaphthalamide), Saytex 120 (tetradecaboromodiphenoxybenzene), and Great Lake under trade name BC-52, BC-58, Esschem Inc under the trade name FR1025.

Suitable phosphorus-containing flame retardants include various organic phosphorous compounds, for example an aromatic phosphate of the formula (GO)₃P═O, wherein each G is independently an C₁₋₃₆ alkyl, cycloalkyl, aryl, alkylarylene, or arylalkylene group, provided that at least one G is an aromatic group. Two of the G groups can be joined together to provide a cyclic group, for example, diphenyl pentaerythritol diphosphate. Other suitable aromatic phosphates can be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like. Examples of suitable di- or polyfunctional aromatic phosphorous-containing compounds include resorcinol tetraphenyl diphosphate (RDP), the bis (diphenyl) phosphate of hydroquinone, and the bis(diphenyl) phosphate of bisphenol-A, respectively, their oligomeric and polymeric counterparts, and the like.

Metal phosphinate salts can also be used. Examples of phosphinates are phosphinate salts such as for example alicyclic phosphinate salts and phosphinate esters. Further examples of phosphinates are diphosphinic acids, dimethylphosphinic acid, ethylmethylphosphinic acid, diethylphosphinic acid, and the salts of these acids, such as for example the aluminum salts and the zinc salts. Examples of phosphine oxides are isobutylbis(hydroxyalkyl) phosphine oxide and 1,4-diisobutylene-2,3,5,6-tetrahydroxy-1,4-diphosphine oxide or 1,4-diisobutylene-1,4-diphosphoryl-2,3,5,6-tetrahydroxycyclohexane. Further examples of phosphorous-containing compounds are NH1197® (Chemtura Corporation), NH1511® (Chemtura Corporation), NcendX P-30® (Albemarle), Hostaflam OP5500® (Clariant), Hostaflam OP910® (Clariant), EXOLIT 935 (Clariant), and Cyagard RF 1204®, Cyagard RF 1241® and Cyagard RF 1243R (Cyagard are products of Cytec Industries). In a particularly advantageous embodiment, a halogen-free polyurethane phase-change composition has excellent flame retardance when used with EXOLIT 935 (an aluminum phosphinate). Still other flame retardants include melamine polyphosphate, melamine cyanurate, Melam, Melon, Melem, guanidines, phosphazanes, silazanes, DOPO (9,10-dihydro-9-oxa-10 phosphenathrene-10-oxide), and DOPO (10-5 dihydroxyphenyl, 10-H-9 oxaphosphaphenanthrenelo-oxide).

Suitable metal oxide flame retardants are magnesium hydroxide, aluminum hydroxide, zinc stannate, and boron oxide. A flame retardant additive can be present in an amount known in the art for the particular type of additive used.

Exemplary antioxidants include radical scavengers and metal deactivators. A non-limiting example of a free radical scavenger is poly[[6-(1,1,3,3-tetramethylbutyl)amino-s-triazine-2,4-dyil][(2,2,6,6-tetramethyl-4-piperidyl)imino]hexamethylene[(2,2,6,6-tetramethyl-4-piperidyl)imino]], commercially available from Ciba Chemicals under the tradename Chimassorb 944. A non-limiting example of a metal deactivator is 2,2-oxalyldiamido bis[ethyl 3-(3,5-di-t-butyl-4-hydroxyphenyl)propionate] commercially available from Chemtura Corporation under the tradename Naugard XL-1. A single antioxidant or a mixture of two or more antioxidants can be used. Antioxidants are typically present in amounts of up to 3 wt. %, specifically 0.5 to 2.0 wt. %, based on the total weight of the polyurethane phase-change composition.

An article comprising the polyurethane phase-change composition can be manufactured by injecting the curable composition into an article, for example into a cavity in the article, and curing the curable composition. The cavity of the article can be of any shape or size. As described above, however, the polyurethane phase-change composition is especially useful for small cavities or cavities with intricate features, because such cavities can be readily filled by the curable compositions.

An article comprising the polyurethane phase-change composition can also be manufactured by coating the curable composition onto an article and curing the curable composition to form the polyurethane phase-change composition. The polyurethane phase-change composition can be implemented as a coating, laminate, film, or sheet using any suitable technique for coating, laminating, or layering the curable composition.

The curable composition can be formed into an article by known methods, for example extruding, molding, or casting. For example, a layer of the polyurethane phase-change composition can be formed by casting the curable composition onto a carrier from which the cured polyurethane phase-change composition layer can later be released, or alternatively onto a substrate. The articles can be any normally employing a polyurethane, for example gaskets, protective packaging, thermal insulation, gel pads, print rollers, electronic parts, straps, bands, autos, furniture, bedding, carpet underlay, shoe inserts, fabric coatings, and the like.

The polyurethane phase-change composition can be used in a variety of applications. The polyurethane phase-change compositions can be used in a wide variety of electronic devices, including hand-held electronic devices, and any other devices that generate heat to the detriment of the performance of the processors and other operating circuits (memory, video chips, telecom chips, and the like). Examples of such electronic devices include cell phones, PDAs, smart-phones, tablets, laptop computers, and other generally portable devices. However, the polyurethane phase-change compositions can be incorporated into virtually any electronic device that requires cooling during operation. For example, electronics used in LED devices, automotive components, aircraft components, radar systems, guidance systems, and GPS devices incorporated into civilian and military equipment and other vehicles can benefit from aspects of the present invention such as engine control units (ECU), airbag modules, body controllers, door modules, cruise control modules, instrument panels, climate control modules, anti-lock braking modules (ABS), transmission controllers, and power distribution modules. The polyurethane phase-change compositions and articles thereof can also be incorporated into the casings of electronics or other structural components, or into batteries. In general, any device that relies on the performance characteristics of an electronic processor or other electronic circuit can benefit from the increased or more stable performance characteristics resulting from utilizing aspects of the polyurethane phase-change compositions disclosed herein.

The polyurethane phase-change compositions described herein can provide improved thermal stability to a device, resulting in the ability to avoid degradation of performance and lifetime of the electronic devices. The polyurethane phase-change compositions are advantageous because the curable compositions can be cast, solvent-free, as films and then cured for use in thermal management applications. The polyurethane phase-change compositions are further advantageous for use as thermal management materials, especially in electronics, because the curable compositions can easily be introduced into cavities of irregular shapes that can be difficult to fill completely with solid phase-change composition, permitting maximum heat absorption capacity, while at a temperature below the operating temperature of the device (e.g., less than 100° C.), avoiding damage to any electronic parts.

The following examples are merely illustrative of the polyurethane phase-change compositions and methods of manufacture disclosed herein and are not intended to limit the scope hereof.

### EXAMPLES

The melting temperature and enthalpy (ΔH) of the transition of a material can be determined by differential scanning calorimetry (DSC), e.g., using a Perkin Elmer DSC 4000, or equivalent, according to ASTM D3418. The material subjected to DSC can be a phase-change material, an encapsulated phase-change material, the phase-change composition, or the polyurethane phase-change composition.

### Example 1. Injectable Polyurethane Phase-Change Composition

Component A was made of a mixture including 21 grams of KRASOL HLBH-P-3000 polyol (Cray Valley USA, LLC), 1.1 grams of REAXIS C216 (dioctyltin dilaurate catalyst, Reaxis, Inc.) and 27.9 grams of fully melted PURETEMP 37 (vegetable oil-based; PureTemp LLC.)

Component B was made of a mixture including 7 grams of an isocyanate prepolymer prepared by isocyanate-functionalizing castor oil to obtain a % isocyanate (NCO) of 7.76% and functionality of about 2.7 (“XP527”; Anderson Development Co.), and 43 grams fully melted PURETEMP 37.

TABLE 1
Components of Curable Composition

| Component A | | Component B | |
|---|---|---|---|
| Ingredient | Weight (g) | Ingredient | Weight (g) |
| P3000 | 21 | XP527 | 7 |
| PURETEMP 37 | 27.9 | PURETEMP 37 | 43 |
| C216 | 1.1 | | |

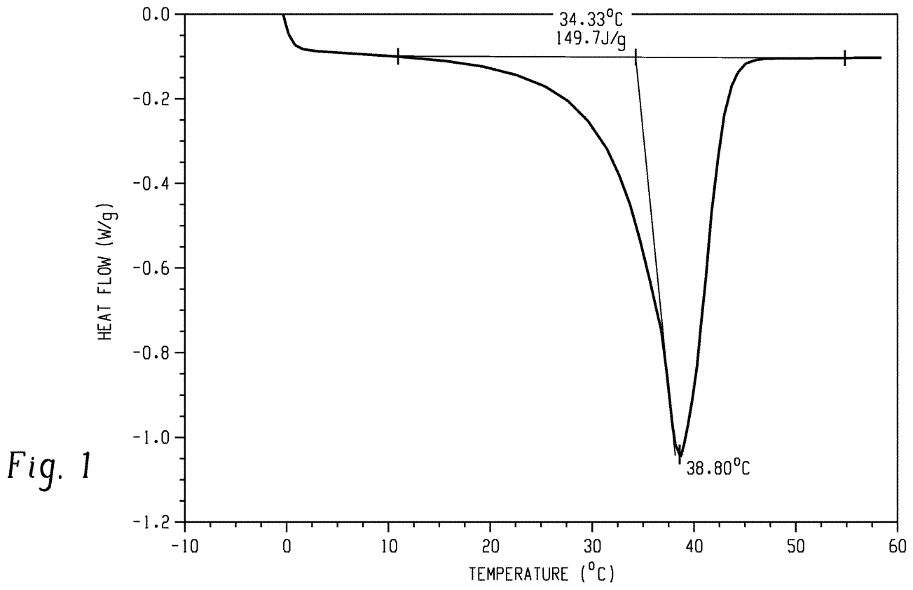

Components A and B were mixed at about 60° C. and then the mixture was injected into an electronics device. The mixture started gelling around 9 minutes after mixing to form an elastomer. As shown in FIG. 1, the gelled polyurethane phase-change composition has a heat of fusion of about 149.7 J/g

### Example 2. Polyurethane Phase-change Film

Component A is a mixture made of 8.5 grams of HLBH-P-3000 polyol, 27.1 grams of MPCM37D (encapsulated phase-change materials, Microtek Laboratories, Inc.), 0.4 gram of REAXIS C216, and 14 grams fully melted PURETEMP 37.

Component B is a mixture made of 2.8 grams of XP527, 31.8 grams of MPCM37D, and 15.4 grams of fully melted PURETEMP 37.

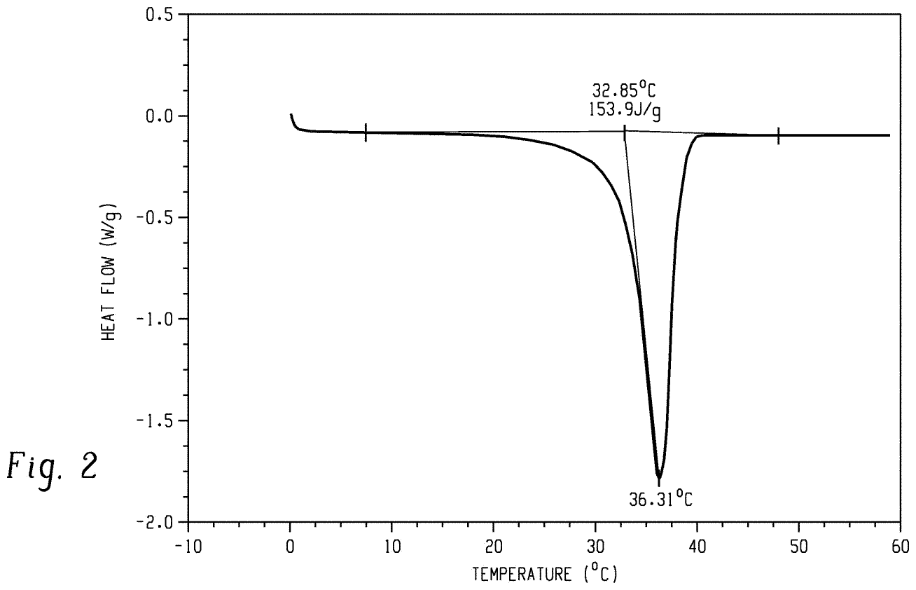

Components A and B were mixed at about 60° C. Then, the mixture was coated onto a PET/PSA film. The film was cured at 325° F. for 15 minutes. A layer of PET/PSA film was laminated onto the top of the polyurethane phase-change composition-coated film. FIG. 2 shows the DSC result for the produced film. As shown in FIG. 2, the heat of fusion is about 153.9 J/g for a 0.24 mm thick film of the polyurethane phase-change composition.

### Example 3. Polyurethane Phase-Change Composition with a Chain Extender

In this example, the effect of inclusion of a chain extender, 1,4-butanediol (BD) on the elastomer product was studied.

Component concentrations of the curable composition including BD are summarized in Table 1 below.

TABLE 2
Components of Curable Composition

| Ingredient | wt % |
|---|---|
| P-3000 | 12.8% |
| BD | 0.5% |
| XP527 | 10.2% |
| PURETEMP 37 | 75.4% |
| C216 | 1.1% |

12.8 parts of HLBH-P-3000 polyol, 0.5 parts of BD, and 10.2 parts of XP527 isocyanate were added into a jar and mixed by FlackTek high speed mixer at 2500 rpm for one minute. 75.4 parts of melted PURETEMP 37 was added into the mixture and mixed by FlackTek high speed mixer at 2500 rpm for one minute. The mixture became cloudy. 1.1 parts of REAXIS C216 was added into the mixture and mixed with the FlackTek high speed mixer at 2500 rpm for one minute. The mixture was placed into a 100° C. gel time tester. After 10 minutes, the mixture was cured and formed a transparent soft gel.

### Example 4. Polyurethane Phase-Change Composition without Catalyst

A curable composition was made by the procedure described above in Example 3 with components identical to those in Table 1 but lacking the catalyst. The curable composition was placed into a 100° C. oven overnight. The composition formed a transparent gel with softness comparable to the gel in example 3.

The claims are further illustrated by the following Aspects, which are non-limiting.

Aspect 1. A method of manufacturing a polyurethane phase-change composition comprises forming a curable composition comprising a homogeneous mixture of an organic isocyanate, a polyol having a hydroxyl functionality of 1.5 to 5, preferably 1.5 to 2.9, and a phase-change material; and curing the curable composition to obtain a polyurethane phase-change composition, wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

Aspect 2. The method of aspect 1, wherein forming a curable composition comprises: combining a first component comprising a homogeneous mixture of the organic isocyanate and the phase-change material, preferably the phase-change material is melted; and a second component comprising a homogeneous mixture of the polyol and the phase-change material, preferably the phase-change material is melted, to form the curable composition.

Aspect 3. The method of aspect 1 or 2, wherein the polyol comprises a polyester polyol, a polyether polyol, a polycaprolactone, a hydrogenated hydroxyl-terminated polyolefin, a hydroxyl-terminated polybutadiene, or a combination thereof; preferably the polyol comprises a hydrogenated hydroxyl-terminated polyolefin, a hydroxyl-terminated polybutadiene, or a combination thereof.

Aspect 4. The method of any one or more of aspects 1 to 3, wherein the number average molecular weight of the polyol is 500 to 10000, or 600 to 8000, or 700 to 6000, or preferably 800 to 4000.

Aspect 5. The method of any one or more of aspects 1 to 4, wherein the organic isocyanate comprises hexamethylene diisocyanate, 1,8-diisocyanato-p-methane, xylyl diisocyanate, diisocyanatocyclohexane, phenylene diisocyanate, toluene diisocyanate, bis(4-isocyanatophenyl)methane, chlorophenylene diisocyanate, diphenylmethane-4,4′-diisocyanate, naphthalene-1,5-diisocyanate, triphenylmethane-4,4′,4″-triisocyanate, isopropylbenzene-alpha-4-diisocyanate, an isocyanate terminated polybutadiene, an isocyanate terminated polyolefin, an isocyanate-derivatized vegetable oil, a prepolymer comprising at least one of the foregoing, a quasi-prepolymer comprising at least one of the foregoing, or a combination thereof; preferably the organic isocyanate is an isocyanate-derivatized vegetable oil; more preferably the organic isocyanate is an isocyanate-derivatized castor oil.

Aspect 6. The method of any one or more of aspects 1 to 5, wherein the phase-change material comprises a C₁₀₋₃₅ alkane, C₁₀₋₃₅ fatty acid, C₁₀₋₃₅ fatty acid ester, a vegetable oil, or a combination thereof.

Aspect 7. The method of any one or more of aspects 1 to 6, wherein the phase-change material comprises an encapsulated phase-change material.

Aspect 8. The method of any one or more of aspects 1 to 7, wherein the phase-change material comprises 10 to 95 weight percent, 30 to 90 weight percent, 40 to 75 weight percent, or 50 to 70 weight percent of encapsulated phase-change material, based on the total weight of the phase-change material.

Aspect 9. The method of any one or more of aspects 1 to 8, wherein the phase-change material is present in the polyurethane phase-change composition an amount of 40 to 95 weight percent, or 50 to 95 weight percent, or 60 to 95 weight percent, or 70 to 95 weight percent, or 80 to 95 weight percent, or 90 to 95 weight percent, or 50 to 90 weight percent, or 60 to 90 weight percent, or 70 to 85 weight percent, or 80 to 90 weight percent, based on the total weight of the polyurethane phase-change composition.

Aspect 10. The method of any one or more of aspects 1 to 9, wherein the phase-change material has a melting transition temperature, determined by differential scanning calorimetry according to ASTM D3418, of 5 to 70° C., 20 to 65° C., 25 to 60° C., 30 to 50° C., or 35 to 45° C.

Aspect 11. The method of any one or more of aspects 1 to 10, wherein the polyurethane phase-change composition has a heat of fusion, determined by differential scanning calorimetry according to ASTM D3418, at the transition temperature of at least 140 Joules/gram, preferably at least 170 Joules/gram, more preferably at least 190 Joules/gram.

Aspect 12. The method of any one or more of aspects 1 to 10, wherein the curable composition further comprises an additive composition, wherein the additive composition comprises a flame retardant, a thermal stabilizer, an antioxidant, a thermoconductive filler, a thermally insulating filler, a magnetic filler, a colorant, or a combination thereof.

Aspect 13. The method of aspect 12, wherein the flame retardant comprises a metal carbonate, a metal hydrate, a metal oxide, a halogenated organic compound, an organic phosphorus-containing compound, a nitrogen-containing compound, a phosphinate salt, or a combination thereof; or the flame retardant preferably comprises aluminum trihydroxide, magnesium hydroxide, antimony oxide, decabromodiphenyl oxide, decabromodiphenyl ethane, ethylene-bis (tetrabromophthalimide), melamine, zinc stannate, boron oxide, or a combination thereof.

Aspect 14. The method of aspect 12 or 13, wherein the additive composition is present in an amount up to 50 weight percent, or 0.01 to 30 weight percent, or 0.01 to 15 weight percent, or 0.01 to 10 weight percent or 0.01 to 5 weight percent, wherein weight percent is based on the total weight of the polyurethane phase-change composition, and weight percents total to 100 weight percent.

Aspect 15. The method of any one or more of aspects 1 to 14, wherein the curable composition further comprises a catalyst.

Aspect 16. The method of aspect 15, wherein the catalyst is a metal catalyst, wherein the metal is tin, bismuth, iron, zinc, or a combination thereof, preferably the metal catalyst is an organometal catalyst.

Aspect 17. The method of any one or more of aspects 1 to 16, wherein the curable composition further comprises a chain extender, preferably the chain extender is 1,4-butanediol.

Aspect 18. The method of any one or more of aspects 1 to 14, further comprising injecting the curable composition into an article; or coating the curable composition onto an article.

Aspect 19. A polyurethane phase-change composition made by the method of any one or more of aspects 1 to 18.

Aspect 20. A polyurethane phase-change composition comprising the reaction product of a homogeneous mixture of an organic isocyanate, a polyol having a hydroxyl functionality of 1.5 to 5, preferably 1.5 to 2.9, and a phase-change material wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

Aspect 21. The polyurethane phase-change composition of aspect 20, wherein the polyol comprises a polyester polyol, a polyether polyol, a polycaprolactone, a hydrogenated hydroxyl-terminated polyolefin, a hydroxyl-terminated polybutadiene, or a combination thereof; preferably the polyol comprises a hydrogenated hydroxyl-terminated polyolefin, a hydroxyl-terminated polybutadiene, or a combination thereof.

Aspect 22. The polyurethane phase-change composition of aspect 20 or 21, wherein the number average molecular weight of the polyol is 500 to 10000, or 600 to 8000, or 700 to 6000, or preferably 800 to 4000.

Aspect 23. The polyurethane phase-change composition of any one or more of aspects 20 to 22, wherein the organic isocyanate comprises hexamethylene diisocyanate, 1,8-diisocyanato-p-methane, xylyl diisocyanate, diisocyanatocyclohexane, phenylene diisocyanate, toluene diisocyanate, bis(4-isocyanatophenyl)methane, chlorophenylene diisocyanate, diphenylmethane-4,4′-diisocyanate, naphthalene-1,5-diisocyanate, triphenylmethane-4,4′,4″-triisocyanate, isopropylbenzene-alpha-4-diisocyanate, an isocyanate terminated polybutadiene, an isocyanate terminated polyolefin, an isocyanate-derivatized vegetable oil, a prepolymer comprising at least one of the foregoing, a quasi-prepolymer comprising at least one of the foregoing, or a combination thereof; preferably the organic isocyanate is an isocyanate-derivatized vegetable oil; more preferably the organic isocyanate is an isocyanate-derivatized castor oil.

Aspect 24. The polyurethane phase-change composition of any one or more of aspects 20 to 23, wherein the phase-change material comprises a C10-35 alkane, C10-35 fatty acid, C10-35 fatty acid ester, a vegetable oil, or a combination thereof.

Aspect 25. The polyurethane phase-change composition of any one or more of aspects 20 to 24, wherein the phase-change material comprises an encapsulated phase-change material.

Aspect 26. The polyurethane phase-change composition of any one or more of aspects 20 to 25, wherein the phase-change material comprises 10 to 95 weight percent, 30 to 90 weight percent, 40 to 75 weight percent, or 50 to 70 weight percent encapsulated phase-change material, based on the total weight of the phase-change material.

Aspect 27. The polyurethane phase-change composition of any one or more of aspects 20 to 26, wherein the phase-change material is present in the polyurethane phase-change composition an amount of 40 to 95 weight percent, or 50 to 95 weight percent, or 60 to 95 weight percent, or 70 to 95 weight percent, or 80 to 95 weight percent, or 90 to 95 weight percent, or 50 to 90 weight percent, or 60 to 90 weight percent, or 70 to 85 weight percent, or 80 to 90 weight percent, based on the total weight of the polyurethane phase-change composition.

Aspect 28. The polyurethane phase-change composition of any one or more of aspects 20 to 27, wherein the phase-change material has a melting transition temperature, determined by differential scanning calorimetry according to ASTM D3418, of 5 to 70° C., 20 to 65° C., 25 to 60° C., 30 to 50° C., or 35 to 45° C.

Aspect 29. The polyurethane phase-change composition of any one or more of aspects 20 to 28, having a heat of fusion, determined by differential scanning calorimetry according to ASTM D3418, at the transition temperature of at least 140 Joules/gram, preferably at least 170 Joules/gram, more preferably at least 190 Joules/gram.

Aspect 30. The polyurethane phase-change composition of any one or more of aspects 20 to 29, wherein the homogeneous mixture further comprises an additive composition, wherein the additive composition comprises a flame retardant, a thermal stabilizer, an antioxidant, a thermoconductive filler, a thermally insulating filler, a magnetic filler, a colorant, or a combination thereof.

Aspect 31. The polyurethane phase-change composition of aspect 30, wherein the flame retardant comprises a metal carbonate, a metal hydrate, a metal oxide, a halogenated organic compound, an organic phosphorus-containing compound, a nitrogen-containing compound, a phosphinate salt, or a combination thereof; or the flame retardant preferably comprises aluminum trihydroxide, magnesium hydroxide, antimony oxide, decabromodiphenyl oxide, decabromodiphenyl ethane, ethylene-bis (tetrabromophthalimide), melamine, zinc stannate, boron oxide, or a combination thereof.

Aspect 32. The polyurethane phase-change composition of aspect 30 or 31, wherein the additive composition is present in an amount up to 50 weight percent, or 0.01 to 30 weight percent, or 0.01 to 15 weight percent, or 0.01 to 10 weight percent or 0.01 to 5 weight percent, wherein weight percent is based on the total weight of the polyurethane phase-change composition, and weight percents total to 100 weight percent.

Aspect 33. The polyurethane phase-change composition of any one or more of aspects 20 to 32, wherein the homogeneous mixture further comprises a catalyst.

Aspect 34. The polyurethane phase-change composition of aspect 33, wherein the catalyst is a metal catalyst, wherein the metal is tin, bismuth, iron, zinc, or a combination thereof, preferably the metal catalyst is an organometal catalyst.

Aspect 35. The polyurethane phase-change composition of any one or more of aspects 20 to 34, wherein the homogeneous mixture further comprises a chain extender, preferably the chain extender is 1,4-butanediol.

Aspect 36. An article comprising the polyurethane phase-change composition of any one or more of aspects 19 to 35 or made by the method of any one or more of aspects 1 to 18.

Aspect 37. The article of aspect 36, wherein the polyurethane phase-change composition is disposed in a cavity of the article.

Aspect 38. The article of aspect 36 or 37, wherein the article is an injection mold, a film, or an electronic device, preferably a hand-held electronic device, an LED device, or a battery.

In general, the articles and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

The singular forms “a,” “an,” and “the” include plural referents unless the context clearly dictates otherwise. “Or” means “and/or.” Unless defined otherwise, technical and scientific terms used herein have the same meaning as is commonly understood by one of skill in the art to which the claims belong. A “combination” is inclusive of blends, mixtures, alloys, reaction products, and the like. The values described herein are inclusive of an acceptable error range for the particular value as determined by one of ordinary skill in the art, which will depend in part on how the value is measured or determined, i.e., the limitations of the measurement system. The endpoints of all ranges directed to the same component or property are inclusive of the endpoints and intermediate values, and independently combinable. Disclosure of a narrower range or more specific group in addition to a broader range is not a disclaimer of the broader range or larger group. A “combination thereof” is open and includes combinations of one or more of the named elements optionally together with one or more like element not named.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosed subject matter is described herein in terms of some embodiments and representative examples, those skilled in the art will recognize that various modifications and improvements can be made to the disclosed subject matter without departing from the scope thereof. Additional features known in the art likewise can be incorporated. Moreover, although individual features of some embodiments of the disclosed subject matter can be discussed herein and not in other embodiments, it should be apparent that individual features of some embodiments can be combined with one or more features of another embodiment or features from a plurality of embodiments.

What is claimed is:

1. A method of manufacturing a polyurethane phase-change composition, the method comprising:
forming a curable composition comprising a homogeneous mixture of an organic isocyanate, a polyol having a hydroxyl functionality of 1.5 to 5, and a phase-change material; and
curing the curable composition to obtain a polyurethane phase-change composition,
wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

2. The method of claim 1, wherein forming a curable composition comprises: combining
a first component comprising a homogeneous mixture of the organic isocyanate and the phase-change material, and
a second component comprising a homogeneous mixture of the polyol and the phase-change material to form a polyurethane phase-change composition.

3. The method of claim 1, wherein the polyol comprises a polyester polyol, a polyether polyol, a polycaprolactone, a hydrogenated hydroxyl-terminated polyolefin, a hydroxyl-terminated polybutadiene, or a combination thereof.

4. The method of claim 1, wherein the number average molecular weight of the polyol is 500 to 10000 Da, or 600 to 8000 Da, or 700 to 6000 Da, or 800 to 4000 Da.

5. The method of claim 1, wherein the organic isocyanate comprises hexamethylene diisocyanate, 1,8-diisocyanato-p-methane, xylyl diisocyanate, diisocyanatocyclohexane, phenylene diisocyanate, toluene diisocyanate, bis(4-isocyanatophenyl)methane, chlorophenylene diisocyanate, diphenylmethane-4,4′-diisocyanate, naphthalene-1,5-diisocyanate, triphenylmethane-4,4′,4″-triisocyanate, isopropylbenzene-alpha-4-diisocyanate, an isocyanate terminated polybutadiene, an isocyanate terminated polyolefin, an isocyanate-derivatized vegetable oil, a prepolymer comprising at least one of the foregoing, a quasi-prepolymer comprising at least one of the foregoing, or a combination thereof.

6. The method of claim 1, wherein the phase-change material comprises a C10-35 alkane, C10-35 fatty acid, C10-35 fatty acid ester, a vegetable oil, or a combination thereof.

7. The method of claim 1, wherein the phase-change material comprises an encapsulated phase-change material.

8. The method of claim 1, wherein the phase-change material comprises 10 to 95 weight percent, 30 to 90 weight percent, 40 to 75 weight percent, or 50 to 70 weight percent encapsulated phase-change material, based on the total weight of the phase-change material.

9. The method of claim 1, wherein the phase-change material is present in the polyurethane phase-change composition an amount of 40 to 95 weight percent, or 50 to 95 weight percent, or 60 to 95 weight percent, or 70 to 95 weight percent, or 80 to 95 weight percent, or 90 to 95 weight percent, or 50 to 90 weight percent, or 60 to 90 weight percent, or 70 to 85 weight percent, or 80 to 90 weight percent, based on the total weight of the polyurethane phase-change composition.

10. The method of claim 1, wherein the phase-change material has a melting transition temperature, determined by differential scanning calorimetry according to ASTM D3418, of 5 to 70° C., 20 to 65° C., 25 to 60° C., 30 to 50° C., or 35 to 45° C.

11. The method of claim 1, wherein the polyurethane phase-change composition has a heat of fusion, determined by differential scanning calorimetry according to ASTM D3418, at the transition temperature of at least 140 Joules/gram.

12. The method of claim 1, wherein the curable composition further comprises an additive composition, wherein the additive composition comprises a flame retardant, a thermal stabilizer, an antioxidant, a thermoconductive filler, a thermally insulating filler, a magnetic filler, a colorant, or a combination thereof.

13. The method of claim 12, wherein
the flame retardant comprises a metal carbonate, a metal hydrate, a metal oxide, a halogenated organic compound, an organic phosphorus-containing compound, a nitrogen-containing compound, a phosphinate salt, or a combination thereof.

14. The method of claim 12, wherein the additive composition is present in an amount up to 50 weight percent, or 0.01 to 30 weight percent, or 0.01 to 15 weight percent, or 0.01 to 10 weight percent or 0.01 to 5 weight percent, wherein weight percent is based on the total weight of the polyurethane phase-change composition, and weight percents total to 100 weight percent.

15. The method of claim 1, wherein the curable composition further comprises a catalyst.

16. The method of claim 15, wherein the catalyst is a metal catalyst, wherein the metal is tin, bismuth, iron, zinc, or a combination thereof.

17. The method of claim 1, wherein the curable composition further comprises a chain extender.

18. The method of claim 1, further comprising
injecting the curable composition into an article; or
coating the curable composition onto an article.

19. A polyurethane phase-change composition made by the method of claim 1.

20. A polyurethane phase-change composition comprising the reaction product of a homogeneous mixture of an organic isocyanate, a polyol having a hydroxyl functionality of 1.5 to 5, and a phase-change material wherein the polyurethane phase-change composition has a transition temperature, determined by differential scanning calorimetry according to ASTM D3418, of 5 to 70° C., 20 to 65° C., 25 to 60° C., 30 to 50° C., or 35 to 45° C.

21. An article comprising the polyurethane phase-change composition of claim 20.

22. The article of claim 21, wherein the polyurethane phase-change composition is disposed in a cavity of the article.

23. The article of claim 21, wherein the article is an injection mold, a film, or an electronic device, an LED device, or a battery.
